(19) United States
(12) Patent Application Publication
(10) Pub. No.: US 2013/0024285 A1
(43) Pub. Date: Jan. 24, 2013

(54) Assured comprehension advertising system

(71) Applicant: William Vincent Quinn, Crofton, MD (US)

(72) Inventor: William Vincent Quinn, Crofton, MD (US)

(21) Appl. No.: 13/507,967

(22) Filed: Aug. 8, 2012

Related U.S. Application Data
(63) Continuation of application No. 13/199,775, filed on Sep. 7, 2011, now abandoned.
Application No. 13/199,775 is a continuation of application No. 11/801,378, filed on May 8, 2007.

(51) Int. Cl. G06Q 30/02

(52) U.S. Cl. 705/14.58; 705/14.69

(57) ABSTRACT

Methods and apparatus for providing messages (12) with embedded advertising (20) that are sent by a sender (10) to a recipient (14) who share an affiliation (27) with a common organization (24) are disclosed.

### REFERENCE TO OTHER RELATED PATENT APPLICATIONS, CLAIMS FOR PRIORITY & INCORPORATION BY REFERENCE

The Present Application is a Continuation Application based on U.S. Ser. No. 13/799,775, filed on 7 Sep. 2011, which is a Continuation Application based on parent application U.S. Ser. No. 11/801,378, filed on 8 May 2007.

The Applicant claims the benefit of priority for any subject matter under 35 USC Sections 119 and/or 120 which is commonly disclosed in the Present Application, and in U.S. Ser. No. 13/799,775 and U.S. Ser. No. 11/801,378.

The text and drawings of U.S. Ser. No. 13/799,775 and U.S. Ser. No. 11/801,378 are hereby incorporated by reference.

### FEDERALLY SPONSORED RESEARCH OR DEVELOPMENT

None.

### FIELD OF THE INVENTION

The present invention pertains to methods and apparatus for composing, delivering and receiving messages. More particularly, one specific embodiment of the invention pertains to an electronic message, such as an e-mail, which is conveyed from a sender to a recipient.

### BACKGROUND OF THE INVENTION

In the year 2006, U.S. companies will spend approximately $140 billion dollars on various forms of advertising. Some of the ads purchased by this sum will be conveyed by broadcast television and radio, and some will be embodied in printed media such as newspapers, magazines, billboards or direct mail.

While these methods for promoting products and services may potentially reach millions of individual viewers or listeners, the number of times that the intended recipient of an advertisement actually reads or listens to the message of the ad is difficult to measure, and can sometimes be extremely low. For example, direct mail advertisers usually hope that their promotional materials will be read by a few percent of their recipients.

Over the past decade, an increasing portion of advertising is conducted using the Internet. Internet advertising typically includes a banner, similar to a billboard, on a web site, which when visited by a consumer may be seen and read, and email, which may contain an embedded advertising message. While advertising via the Internet offers a lower cost of distribution, it does not necessarily overcome the challenges that advertisers have in measuring the effectiveness of their advertising.

The Internet is also plagued by unwanted forms of e-mail called “spam.” Spam is reported to account for approximately 40% of all e-mail. In 2006, 12.4 billion spam e-mails will be sent each day, and the average computer user will receive 2,200 spam e-mails. These high figures indicate the potential that advertisers see in leveraging email as a way to advertise directly to the consumer. However, this spam email is generally unwanted by its recipients. Spam causes billions of dollars in lost time and productivity, and reduces the overall proportion of messages that a typical e-mail recipient will read, since so many are unwanted. People have employed technology, called spam filters, to help ward off these unwanted messages. This problem causes billions of dollars in lost time and productivity, and reduces the overall proportion of messages that a typical e-mail recipient will read, since so many are spam.

No currently available advertising method guarantees an exceedingly high rate of probability that advertisements will be read by recipients. The development of such an advertising system would offer immense benefits and satisfy a long felt need in the advertising industry, and would constitute an advance in the field of marketing and promotions.

### SUMMARY OF THE INVENTION

The present invention comprises methods and apparatus for insuring that a high proportion of advertisements are read by their intended recipients. In one particular embodiment of the invention, a message is transmitted by a sender, and then received by an intended recipient. Unlike conventional broadcast or mass-circulated advertising, the present invention is directed to precisely selected pairs of senders and recipients who know of one another through an affiliation with a common organization. Examples of such organizations and affiliated parties are: nonprofit organizations, private employers, youth sport organizations, soccer teams, cub scout packs, elementary schools, teachers, coaches, parents of students, parents of children who play soccer, and officials involved in nonprofits.

The message that is dispatched to an intended recipient includes a first portion and a second portion. The first portion contains a communication that is composed by the sender and that is intended to be read by the recipient. The sender knows of the recipient through their affiliation to a common organization. In many instances, they know one another personally prior to the time that the message is sent to the recipient. The message also includes a second portion. The second portion contains an advertisement. The advertisement is paid for by the advertiser, and a percentage of the payment goes to the organization which the sender and recipient have in common. The sender of the message is motivated to send a message, many times private in nature, that contains an advertisement because the aforementioned common organization receives a payment by an advertiser.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 is a schematic diagram which illustrates one embodiment of the present invention.

FIG. 2 supplies a view of one embodiment of the present invention. An e-mail conveyed from a sender contains an advertisement that is received by a recipient. The sender and the recipient know of one another through an affiliation with a common organization. In this example, the common organization is the Middletown Soccer League. The parents are registered directly with the League, and the League possesses contact information for the parents. The sender is the Soccer League Coordinator, and the recipient is a parent whose child plays soccer in the Soccer League. The e-mail message not only provides a message about soccer practice from the coordinator to the child's parent, but also includes an advertisement placed by an advertiser. The common organization, the Soccer League, receives a payment for the placement of the advertisement.

FIG. 3 shows a parent registering his child for Soccer League. FIG. 4 shows a coach sending a message to the parent shown in FIG. 3 after the parent has registered his child. FIG. 5 shows the coach leaving a conventional voice message, informing one or more parents that a soccer match has been canceled. In FIG. 6, the coach transmits a voice message in accordance with the present invention. This message contains two portions—the notice of cancelation and an advertisement.

FIGS. 7, 8, 9 and 10 are flow charts which illustrate one embodiment of the present invention.

FIG. 11 presents a generalized outline map of the United States, and includes six cities which have regions populated by individuals having high disposable income who may be selected as recipients of the message depicted in FIG. 1.

FIG. 12 is a generalized outline map of Manhattan, which includes the Upper West Side, a region having residents who may be selected as recipients of the message depicted in FIG. 7.

FIG. 13 is a flow chart that illustrates one of the methods of the present invention concerning the selection of recipients.

FIG. 14 shows how the invention is implemented with an intermediary.

### A DETAILED DESCRIPTION OF PREFERRED & ALTERNATIVE EMBODIMENTS

### I. Overview of the Invention

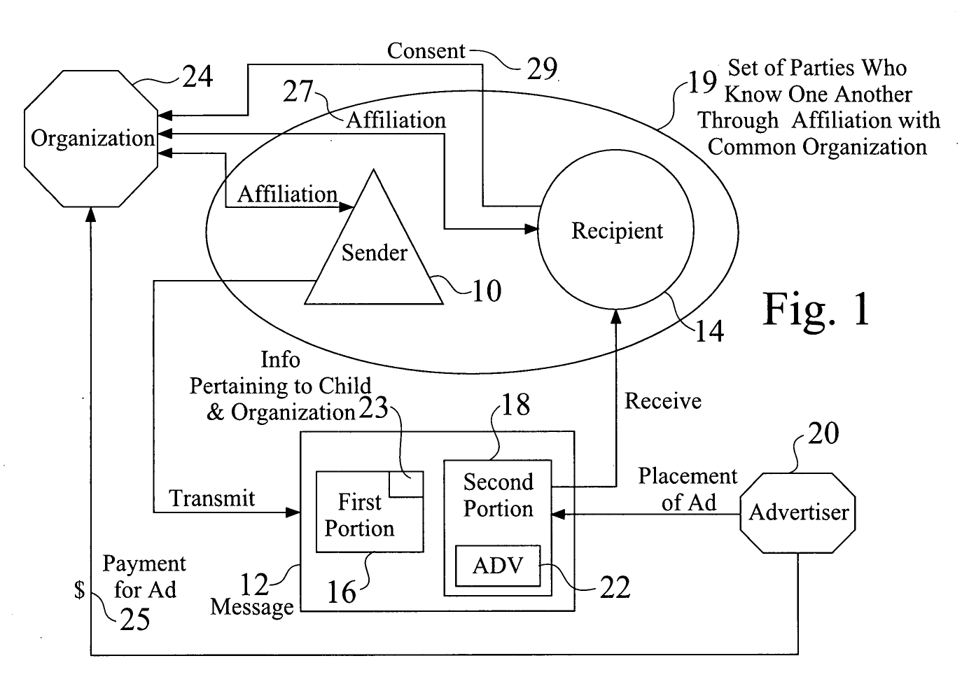

FIG. 1 presents a schematic diagram which illustrates one embodiment of the invention. A sender 10 transmits a message 12 to a recipient 14. This message 12 contains a first portion 16 and a second portion 18. In general, the first portion 16 comprises a communication between the sender 10 and the recipient 14 or a group of recipients. An advertiser 20 has placed an advertisement 22 in the second portion 18 of the message 12. The first portion 16 of the message 12 also includes information 23 pertaining to the recipient's child and to an organization 24 with which both the sender 10 and the recipient 14 are affiliated. In general, all the messages 12 conveyed in accordance with the present invention are sent and/or received by parties 19 who have an affiliation 27 with this common organization 24. The advertiser 20 makes a payment 25 to the organization 24 in exchange for the placement of the advertisement 22, and with the consent 29 of the recipient 14. In an alternative embodiment, the recipient 10 provides the organization 24 with consent 29 in exchange for the payment 25 that the advertiser 20 makes to the organization 24.

The second portion 18 of the message 12 may be inserted into the first portion 16, may be concatenated with the first portion 16 or may simply accompany the first portion 16. In any event, both portions 16 and 18 of the message 12 generally comprise a single communication between the sender 10 and the recipient 14. Although this Specification generally describes the present invention using the singular terms “sender,” “message” and “recipient,” the invention also includes embodiments that utilize a plurality of senders, messages and recipients.

In this Specification and in the Claims that follow, the term “sender” encompasses any person, individual, organization, entity or group who emits, emanates, forwards, issues, propagates, transfers, relays, repeats or otherwise dispatches a message or initiates the sending of a message. The term “message” is intended to include any communication, narrative, bulletin, statement, recitation, data, signal, advice, notice, briefing or other representation of information or intelligence. The term “recipient” means any person or individual who receives, accepts, collects, obtains, procures or otherwise perceives, recognizes, apprehends or comprehends a message.

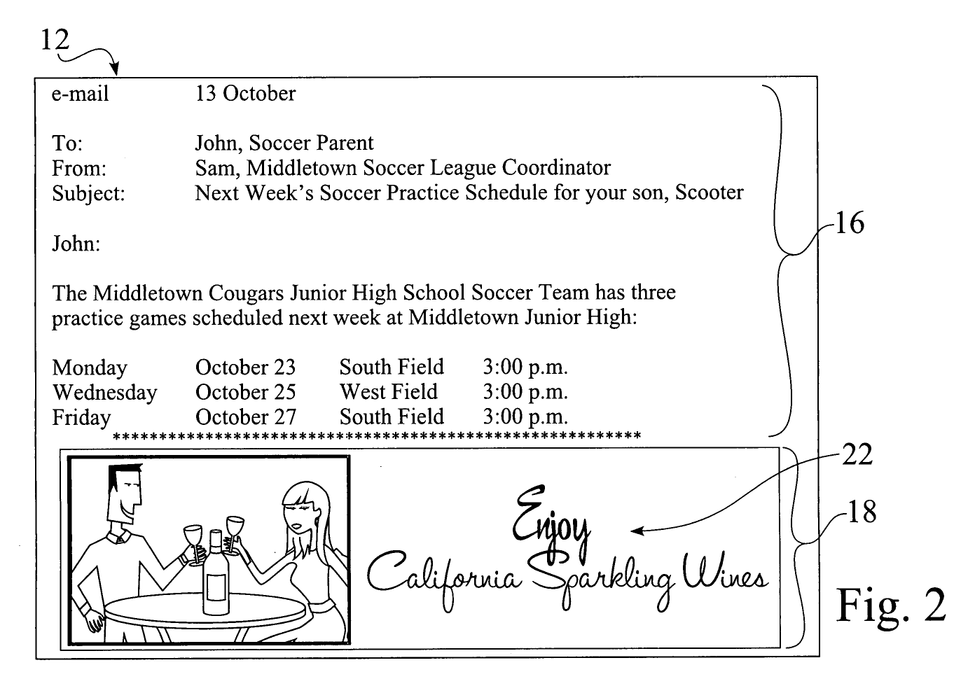

FIG. 2 exhibits a more specific embodiment of the invention, in which the second portion 18 of the message 14 comprises an advertisement 22. In this Specification and in the claims that follow, the term “advertisement” is intended to encompass any communication which recommends, endorses, offers, praises, describes or otherwise promotes a product, service, political candidate, party or position; voting proposition or which markets any other person, item, object or system. The advertisement 22 may include text, graphics, photos, logos, artwork, pattern, meaningful design or any other suitable form of language. In an alternative embodiment, the advertisement 22 may utilize other media beyond the written word or graphics, such as audio or video presentations. The advertisement 22 may also include interactive features or components, which provide the recipient with an opportunity to select additional information using a menu, or which provide the recipient with the ability to respond to an offer, to take specific actions or to request more information. An advertisement 22 is generally composed by an advertiser 20, by some intermediary or agent, or at the request of an advertiser. An advertiser 20 is a person or entity that wishes to advertise or to compose an advertisement 22. In one embodiment, an advertiser 20 is willing to pay cash for the right to place an advertisement 22 in a location or medium where it will be seen by the advertiser's intended or target audience or ideal customer. The term “place” means insert, embed or otherwise interpose the advertisement 22 in the communication between or among the sender and recipients.

Unlike conventional broadcast or mass-circulated advertising, the present invention is directed to precisely selected pairs of senders 10 and recipients 14 who know of one another through an affiliation 27 with a common organization 24. Examples of such organizations and affiliated senders and receivers are: nonprofit organizations, employers, youth organizations, youth sports organizations, youth sport leagues, youth soccer teams, youth sports clubs, cub scout packs, schools, elementary schools, teachers, coaches, parents, parents of students, parents of children who play soccer, parents of youth participants, parents of youth affiliates, children, youths, students, employees, subordinates, and individuals and officials involved in nonprofits or any organization. The sender 10 knows the recipient 14 through their affiliation 27 to a common organization 24. In many instances, the sender 10 and the recipients 14 know one another personally prior to the time that the message 12 is sent to the recipient 14.

The advertisement 22 in the second portion 18 of the message 12 is paid for by an advertiser 20, and a percentage of the payment goes to the organization 24 which the sender 10 and recipient 14 have in common. The sender of the message is motivated to send a message, which is, in many instances, private in nature, and contains an advertisement 22, because the common organization 24 receives a payment by an advertiser 20.

FIG. 2 depicts one specific type of message 12, an e-mail message. This particular example illustrates a message 12 that is transmitted over the Internet, and which may be sent and/or received using a variety of devices, including, but not limited to: a personal computer, a cellular telephone, a conventional telephone, a pager, an information appliance such as a Blackberry™ device or some other personal digital assistant or a television. According to webopedia.com, “e-mail” is an abbreviation for electronic mail, which is defined as:
“the transmission of messages over communications networks. The messages can be notes entered from the keyboard or electronic files stored on disk. Most mainframes, minicomputers, and computer networks have an e-mail system. Some electronic-mail systems are confined to a single computer system or network, but others have gateways to other computer systems, enabling users to send electronic mail anywhere in the world. Companies that are fully computerized make extensive use of e-mail because it is fast, flexible, and reliable.”
“Most e-mail systems include a rudimentary text editor for composing messages, but many allow you to edit your messages using any editor you want. You then send the message to the recipient by specifying the recipient's address. You can also send the same message to several users at once. This is called broadcasting.”
“Sent messages are stored in electronic mailboxes until the recipient fetches them. To see if you have any mail, you may have to check your electronic mailbox periodically, although many systems alert you when mail is received. After reading your mail, you can store it in a text file, forward it to other users, or delete it. Copies of memos can be printed out on a printer if you want a paper copy.”
“All online services and Internet Service Providers (ISPs) offer e-mail, and most also support gateways so that you can exchange mail with users of other systems. Usually, it takes only a few seconds or minutes for mail to arrive at its destination. This is a particularly effective way to communicate with a group because you can broadcast a message or document to everyone in the group at once.”
“Although different e-mail systems use different formats, there are some emerging standards that are making it possible for users on all systems to exchange messages. In the PC world, an important e-mail standard is MAPI. The CCITT standards organization has developed the X.400 standard, which attempts to provide a universal way of addressing messages. To date, though, the de facto addressing standard is the one used by the Internet system because almost all e-mail systems have an Internet gateway.”

Another common type of message which is conveyed over the Internet is an “instant message,” which Webopedia.com defines as:
“a type of communications service that enables you to create a kind of private chat room with another individual in order to communicate in real time over the Internet, analogous to a telephone conversation but using text-based, not voice-based, communication. Typically, the instant messaging system alerts you whenever somebody on your private list is online. You can then initiate a chat session with that particular individual.”

Although one preferred embodiment of the invention may be conveyed in an e-mail or in an instant message, the invention may be implemented using any form of conveyance or message, including, but not limited to, any form of digital audio file delivered via twisted pair land line, cellular, or Internet, including voice-mail or voice messaging, or any form of electronic mail that is delivered over the Internet, including “web-mail.”

According to webopedia.com, web-mail is described as:
“Software run by an ISP or online service that provides access to send, receive, and review e-mail using only your Web browser. Users can simply enter the Webmail Web site URL in their browser's address or location field, and use their Webmail account by typing in a username and password. Webmail provides an easy access and storage of e-mail messages for users who are not connected to the Internet from their usual location. Instead of the e-mail being downloaded to the computer you are checking your e-mail account from, the messages will stay on the provider's server, allowing you access to all e-mail messages regardless of what system or ISP you are connected to the Internet with. Hotmail, Gmail, and Yahoo! mail are all examples of popular webmail providers. Additionally many ISPs offer webmail services to customers in addition to POP e-mail services.”

Other alternative kinds of messages that may be used to implement the present invention include voice-mail and voice messaging. According to wikipedia.org, voice-mail and voice messaging are described as follows:
“Voicemail (or voice mail, vmail or VMS, sometimes called messagebank) is a centralized system of managing telephone messages for a large group of people. In its simplest form it mimics the functions of an answering machine, uses a standard telephone handset for the user interface, and uses a centralized, computerized system rather than equipment at the individual telephone. Voicemail systems are much more sophisticated than answering machines in that they can:
Answer many phones at the same time
Store incoming voice messages in personalized mailboxes associated with the user's phone number
Enable users to forward received messages to another voice mailbox
Send messages to one or more other user voice mailboxes
Add a voice introduction to a forwarded message
Store voice messages for future delivery
Make calls to a telephone or paging service to notify the user a message has arrived in his/her mailbox
Transfer callers to another phone number for personal assistance
Play different message greetings to different callers

Voicemail messages are stored on hard disk drives, media generally used by computers to store other forms of data. Messages are recorded in digitized natural human voice similar to how music is stored on a CD. To retrieve messages, a user calls the system from any phone, logs on using Touch-tones (clearing security), and his/her messages can be retrieved immediately. Many users can retrieve or store messages at the same time on the same voicemail system.”

Voice messaging ‘is to phones what email is to computers. Messages are sent to other users by calling the voicemail system rather than the user's phone. For example, suppose two employees (Fred and Mary) are working on a project. Fred has some information that Mary should have, but doesn't want to phone her and talk to her he just wants to give her the information. Rather than phone her, Fred calls the voicemail system, logs on with his number and password, and records a message to Mary in his own voice. He tells the voicemail system to send it to Mary by keying in her mailbox number (same as her extension) or spelling her name using Touch-tone keys. The message is immediately put in Mary's voice mailbox without her phone ever ringing. The message waiting light on her phone immediately comes on telling her there is a message. Fred can send this message just to Mary, to Mary and any number of additional employees, or to group lists which contain any number of pre-programmed names and numbers. The same message can be sent to thousands of people. Additional features are available, like marking a message urgent, private or asking for notification when the message has been picked up.”

### II. Specific Examples of the Invention

FIG. 2 supplies a view of a specific example of the embodiment of the invention that is portrayed in FIG. 1. The sender 10, Sam, is the coordinator, official or representative of a Soccer League for the Junior High School students in the village of Middletown. This Soccer League is a nonprofit organization 24. In this embodiment, the parents register directly with the League, and the League possesses contact information for the parents. In an alternative embodiment, the nonprofit organization is a Soccer Club. Parents register with the Club, which enters teams into a Soccer League. The Soccer League generally does not communicate directly with the parents. The parental communication generally occurs between or among the Club and the parents.

The recipient 14, Roger, is the parent of one of the students on one of the soccer teams in this league. The student and soccer team member, Scooter, plays for the Middletown Cougars. Three practice games are scheduled for the week following the date of the e-mail. This e-mail is a communication between two parties who are affiliated with a common organization 24. This message 12 conveys the time and place of the practice games from Sam, the coordinator, to Roger, the parent.

E-mail is viewed on physical objects such as computers, telephones, cellular phones, PDAs, and information appliances. The e-mail appears to the viewer as if the viewer is viewing or reading a letter on a piece of paper. The e-mail, and likewise the paper, have physical dimensions with some space taken up by the words and some space seemingly blank or bare. In various embodiments of this invention, advertisements 22 will be placed on these seemingly blank or bare spaces or portions of e-mail, which include but are not limited to: the top, the bottom, the side, the middle, the sporadically located blank areas, the background, and the foreground. The objective is to place advertisements 22 in an artful and attractive manner to the viewer or recipient 14.

The e-mail shown in FIG. 2 is generally divided into two portions, segments or parts. In this embodiment, it is the upper part of the e-mail that is the communication of the schedule information from Sam to Roger, and comprises the first portion 16. The lower part of the e-mail, which resides below the line of asterisks, constitutes the second portion 18, which includes an advertisement 22. This lower part would appear blank without the advertisement 22, and is delineated in FIG. 5 by the space below the line of asterisks.

In accordance with the present invention, Sam is the sender 10 and Roger is the recipient 14. The e-mail is the message 12, and the message 12 comprises two portions. The first portion 16 is the narrative from Sam to Roger, while the second portion 18 is the advertisement 22. This ad 22 promotes California Sparkling Wine. Because Sam and Roger are both affiliated with an organization 24 they are expecting to receive messages, via e-mail or v-mail, from one another with a portion of the message pertaining to the organization 24. In this embodiment, the sender 10 is an official with the Soccer League and has a message 12 pertaining to the soccer schedule.

The recipient 14 is the parent of a child who is on the team; this is the same team that is referenced in the message, which has to do with the team's schedule. The likelihood that Roger, the recipient, will read this e-mail message is very high, compared to the likelihood that he will read e-mails from other senders with whom he has no affiliation or whose subject line does not pertain to his family's personal schedule. This message, including the subject line and narrative, contains information that is considered valuable by the recipient 14. In this case, the information is a schedule which concerns the common organization 24, the youth sports team, in which Sam and Roger participate.

In this Specification and in the Claims that follow, the term “participate” means that an individual is a registered member or is somehow acknowledged, joins in, or is assigned to the activities of an organization 24. A child who participates would be registered with the organization 24. The organization 24 recognizes that the child's parents wishes for the child to have the organization's services or benefits delivered to or made available to the child. As an example, if a the child participates in an organization which conducts sporting events, the child is assigned to a team. In a second example, if the organization is an educational institution, the child is assigned to a class.

Moreover, Roger will become aware that the organization 24, for instance the Soccer League, receives financial benefit in return for allowing the advertiser 20 the right to rent space on the league official's e-mail. The likelihood that Roger will read the embedded advertisement 22 is much higher than the chance that he will view or listen to other forms of advertising, especially given the incremental financial benefit to the organization 24. Any e-mails that Roger receives from Sam will likely be treated as important messages and will not be filtered or treated as spam. One embodiment of the invention encompasses the composition, transmission and reception of e-mails with embedded advertising from persons who organize, coordinate, represent, coach, teach or otherwise participate in nonprofit organizations 24, such as sport leagues, sport clubs, sport teams or academic institutions, which benefit children or students. In another embodiment, the sender is the organization 24 itself. The recipients of these e-mails include the parents, coaches, students, alumni and other individuals who participate or are involved with the organization's activity. The sporting activity may include soccer, football, baseball, basketball, hockey, wrestling, track and field, tennis, golf, field hockey or any other sport, game or competition. In addition to sports, the message may also be directed to school events, functions and activities, such as school services organizations, student government, science or language clubs, cheerleading, dances, pep rallies or any other enterprise involving the school.

In another embodiment, Roger, the recipient, cooperates with the advertiser 20 in a variety of ways, including, but not limited to: providing an e-mail receipt, completing a survey, purchasing the advertised product or service, providing personal data, providing sales leads, and forming contractual relationships.

One example of cooperation would be to confirm, for the benefit of the advertiser 20, that the e-mail was received. In another embodiment, the recipient 14 would reply to the e-mail and type the name of the advertiser 20 as an additional level of proof that the advertisement 22 was read. Another example of cooperation would be to confirm that the advertisement 22 was seen and read. The advertiser 20 would benefit by knowing the exact number of recipients of its advertising, an advertising metric that is not easily ascertained in conventional advertising.

In another embodiment, Roger, the recipient, could answer a survey. In this embodiment, a survey comprises any communication which is more comprehensive than just an e-mail confirmation of receipt. Again, this would provide more information than is likely ascertained in conventional advertising.

In another embodiment, Roger, the recipient, actually orders the merchandise, the California Sparkling Wine. In another embodiment, Roger, the recipient, orders the merchandise in a way that is attributable to the advertisement in the e-mail correspondence having to do with the organization.

In other embodiments, the Middletown Soccer League, the organization 24, receives incrementally more payment as a result of the action taken by Roger, the recipient.

In another embodiment, Roger, the recipient, would provide personal profile information that could be made available to the advertiser 20. Examples of personal profile information are: income, net worth, debt, purchasing habits, age, gender, race, political party, political tendencies, sport fan interests, sport participation interests, vacation destination interests, travel habits, vendor preferences, number of children, children gender, children age, children buying preferences, children schools, profession, employment, sexual orientation, religion, religious institutional affiliations, charity preferences, and charitable organization affiliations. In one embodiment, this information would be kept anonymous, meaning it could not be tied to the identity of Roger. The advertiser 20 would benefit by understanding the exact profile of the recipient. In another embodiment, the advertiser 20 would pay the organization 24 more payment in situations where the recipient profile is known in advance of selecting the advertisement or sending the message.

In another embodiment, the advertisement and recipient are selected using a criteria attractive to the advertiser 20.

In another embodiment, Roger, the recipient, cooperates with the advertiser 20 in a variety of ways, including, but not limited to: providing an e-mail receipt, completing a survey, purchasing the advertised product or service, providing personal data, providing sales leads, and forming contractual relationships.

Because organizations, such as youth sports organizations, can be delineated by marketing and advertising variables, such as geographic region and high disposable income demographics, using publicly available resources such as census data, an advertiser 20 would be able to target more specific advertisements to target customers and audiences. Such targeting is a valuable and sought after attribute that is not easily attained through conventional advertising methods.

### III. Relationships Among Senders and Recipients

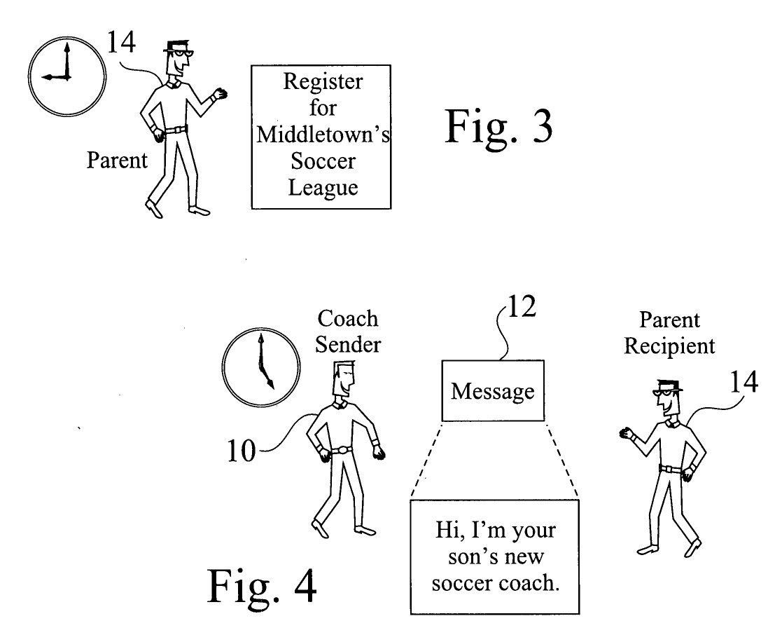

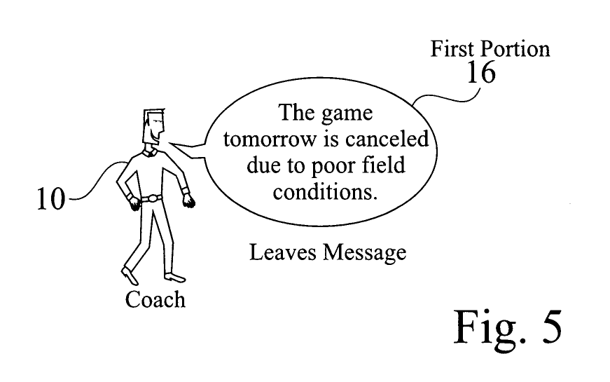

As shown in FIGS. 3, 4, 5 and 6, the sender 10 and the recipient 14 know of one another through their affiliation with a common organization 24, in this case the Middletown Soccer League. FIG. 3 portrays a parent as he registers his child for a Soccer League. Later that day, the soccer coach sends the parent a message, as depicted in FIG. 4.

FIGS. 5 and 6 illustrate an alternative form of communication that employs a voice mail message. In FIG. 5, the coach provides a conventional voice message that notifies a parent that a soccer match is canceled. In FIG. 6, the coach sends a voice message that includes the notification of the canceled match, plus a promotional message.

Thus, sender and receiver have established some kind of relationship prior to the time that a message is conveyed from a sender to a recipient in accordance with the present invention. The affiliation and previous relationship between the sender and the recipient assures the relatively high read rate of both the first and second portions of the message.

When used in this Specification or in the Claims that follow, the use of the phrase “affiliation with a common organization” is intended to describe two or more individuals, parties or entities who have a relationship to a common organization including itself, or who participate in activities related to that common organization, or who have children who participate in activities related to that common organization. The parties may be the organization itself, or the individual members.

The terms “affiliated” or “affiliation” refers to a sender and/or a recipient. In the case of a recipient, “affiliated” means someone who has registered with the organization, or has made their e-mail known to the organization to receive correspondence having to do with the organization. In the case of a sender, “affiliated” means someone (or an entity) who initiates correspondence that contains information having to do with the business of the organization, and is someone (or entity) who is given access by the organization to the e-mail addresses (or other contact info) of the organization.

### IV. The Sender's Purposes & Motivations

The advertisement 22 shown in FIG. 2 was placed in the e-mail with the consent of, with the cooperation of, at the request of, or by the direction of the sender 10. The placement of the advertisement 22 provides a benefit to the nonprofit organization 24 with which the sender 10 and recipient 14 affiliate themselves. More specifically, the benefit may include one or more of the following:
Payment to a nonprofit organization, such as a youth organization
Payment to the employer of sender and receiver
Payment to sender for himself or herself
   The payment may be made in cash, in the form a credit or in some other form of income, exchange, remittance, trade, barter or other value.

When used in this Specification and in the Claims that follow, the term “youth organization” is intended to refer to any group, club, association or other assemblage of individuals which concerns children, minors, student life and/or functions, school, sports or other activities.

In one embodiment of the invention, the sender 10 cooperates with the advertiser 20, or with the advertiser's agent or intermediary to record messages that have been sent on behalf of the advertiser 20. In an alternative embodiment, the advertisement 22 may also provide a benefit to the recipient 14. More specifically, the benefit which is acquired by the recipient 14 of an e-mail message 12 may include one or more of the following:
Recipient obtains payment for an organization, such as a youth organization
Recipient obtains payment for his or her employer
Recipient obtains payment for himself or herself
   The payment to the recipient may be made in cash, in the form a credit or in some other form of income, exchange, remittance, trade, barter or other value.

In one embodiment of the invention, the recipient 14 cooperates with the advertiser 20, or with the advertiser's agent or intermediary to record messages that have been received on behalf of the advertiser. In another embodiment, the recipient has contact with the advertiser as a result of the message sent via the organization affiliation. The recipient may confirm the receipt of a message, may confirm that the advertisement 22 was read, may “click through” to answer a survey, may respond to an offer by ordering goods or services or may provide a recipient personal profile. The information in this profile may be supplied anonymously, but would allow the advertiser 20 to gain more knowledge about recipients.

### V. The Advertiser & Advertisements

In one embodiment, the sender and recipient know of one another through a common affiliation to an organization, profit or non-profit, and the organization has the recipient's resident address, which is located in a statistical area authoritatively known for having attributes attractive to advertisers. One such attribute is being in a statistical area that is authoritatively known to have a average household income above the U.S. national median household income. The present invention provides benefits to an advertiser 20. The advertisement 22 is read by a high proportion of recipients, based on the relationship of the sender and the recipient, such as coach/parent, teacher/parent or supervisor/subordinate. The advertising method provided by the present invention enables target marketing such as high per capita income profiling.

When used in this Specification and in the Claims that follow, the term “authoritatively” is intended to refer to any body that is recognized by either government or industry as having undertaken a scientific or methodical process to determine what is “known” or published or customarily accepted. When used in this Specification and in the Claims that follow, the term “statistical area” is intended to refer to an area published by an authority or commonly accepted authoritatively to be represented by statistical descriptives. Examples of authoritatively known statistical areas are those statistical areas referred to by the U.S. Bureau of the Census, which is an authoritative body. Examples of U.S. Census Bureau statistical areas are: metropolitan statistical area (MSA), consolidated metropolitan statistical area (CMSA), primary metropolitan statistical area (PMSA), census tracts, census block groups (BGs), census county divisions (CCDs), and census designated places (CDPs). An example of a commonly accepted statistical descriptive is a U.S. Postal Service zip code. For example, an advertiser 20 could target a census designated place (CDP) that has a high median income per household.

According to wikipedia.org, the terms “census designated place” and “household income” are described as follows:
“A census-designated place (CDP) is an area identified by the United States Census Bureau for statistical reporting. CDPs are communities that lack separate municipal government, but which otherwise resemble incorporated places such as cities or villages. CDPs are delineated to provide data for settled concentrations of population that are identifiable by name but are not legally incorporated under the laws of the state in which they are located. They are often informally called ‘unincorporated towns.’
The boundaries of such places may be defined in cooperation with local or tribal officials, but are not fixed, and do not affect the status of local government or incorporation. CDP boundaries may change from one census to the next to reflect changes in settlement patterns. Further, as statistical entities, the boundaries of the CDP may not precisely correspond with local understanding of the area with the same name. Recognized communities may be divided into two or more CDPs. A CDP may also cover the unincorporated part of a community where the rest lies within an incorporated city.
By defining an area as a CDP, that locality then appears in the same category of census data as incorporated places. This distinguishes CDPs from other census classifications, such as minor civil divisions (MCDs), which are in a separate category.
However, the CDP has no separate town rights or city councils. The population and demographics of the district are included in the data of county subdivisions containing the CDP. In no case is a CDP defined within the boundaries of an incorporated city, village or borough. However, note that the Census Bureau considers Towns in New England states and New York as well as Townships in some other states as MCDs, even though they are incorporated municipalities in those states.

There are a number of reasons for such a designation:

The area may be more urban than its surroundings, having a concentration of population with a definite residential nucleus, such as Whitmore Lake, Michigan, or Hershey, Pa.

A formerly incorporated place may disincorporate or be partly annexed by a neighboring town, the former town or a part of it may still be reported by the census as a CDP by meeting criteria for a CDP, for example the former village of Covedale, Ohio and compare this with Covedale (CDP), Ohio.

The CDP designation may apply to large military bases (or parts of) that are not within the boundaries of any existing community, such as Fort Campbell and Fort Knox in Kentucky.

In some cases, a CDP may be defined for the urbanized area surrounding an incorporated municipality, but which is outside the municipal boundaries, for example Greater Galesburg, Michigan or Greater Upper Marlboro, Md.

The Census Bureau treats all townships as unincorporated places, even in those states where townships are incorporated under state law. This is so even in those states (i.e., Indiana, Michigan, Minnesota, New Jersey and South Dakota) where the Census Bureau acknowledges that ‘All townships are actively functioning governmental units.’

Some CDPs represent an aggregation of several nearby communities, for example Shorewood-Tower Hills-Harbert, Mich.

Hawaii is the only state that has no incorporated places recognized by the U.S. Census Bureau below the county level. All data for places in Hawaii reported by the Census are CDPs.

In some states, CDPs may be defined within entities that may function as incorporated municipalities, but for the purposes of the census are regarded as minor civil divisions. For example, towns in Massachusetts and Connecticut provide all the services of an incorporated municipality, but may also include both rural and urban areas. CDPs may be defined to describe urbanized areas within such municipalities, as in the case of North Amherst, Massachusetts.

In some states, the Census Bureau may designate an entire minor civil division (MCD) as a CDP (for example West Bloomfield Township, Michigan or Reading, Massachusetts). Such designations are used in states where the MCDs function with strong governmental authority and provide services equivalent to an incorporated municipality (New England, the Middle Atlantic States, Michigan, and Wisconsin). MCDs appear in a separate category in census data from places (i.e., incorporated places and CDPs); however, such MCDs strongly resemble incorporated places, and so CDPs coterminous with the MCDs are defined so that such places appear in both categories of census data.

The Household income in the United States is a measure of private wealth commonly used by the United States government and private institutions. To measure the income of a household, the pre-tax earnings of all residents over the age of 15 are combined. The residents of the household do not have to be related to the householder for their earnings to be considered part of the household's income. The use of household income is often seen as the most dependable measure of personal wealth, as people tend to live in households that include other wage earners besides themselves. In 2004, the median annual household income according to the US Census Bureau was determined to be $43,389, nearly identical to that of Canada which was roughly $41,510 (USD) in the year 2000. The median income per household member (including all working and non-working members above the age of 14) in the year 2003 was $23,535. In the year 2005, there were approximately 113,146,000 households in the United States. 15.73% of all households had annual incomes exceeding $100,000, while another 12.7% fell below the federal poverty threshold. While the aggregate income distribution tends to tilt towards the top with the top 6.37% earning roughly one third of all income, it is important to note that the those with upper-middle incomes controlled an even greater share of the total earned income. Households with moderately high middle class incomes ranging from $50,000 to $100,000 a year, represented 29.2% of all households, yet earned a far greater share (c.a. 40%) of all income.

The 2005 economic survey also found that households in the top two income quintiles, those with an annual household income exceeding $55,331, had a mean of two income earners while those in the lower quintiles (2nd and middle quintile) had mean of only one income earner per household. Due to high unemployment among those in the lowest quintile the mean number of income earners for this particular group was determined to be zero. Overall the United States followed the trend of other industrialized countries with a relatively large population of relatively affluent households outnumbering the poor. Among those in-between the relative extremes of the income strata a large and quite powerful section of households with moderately high middle class incomes and an even larger number of households with moderately low incomes. While the median household income has increased 44% since 1990 it has decreased very slightly when considering inflation. In 1990, the median household income was determined to be $30,056; $44,603 in 2003 dollars. In 2003, the median household income was, however, only $43,389, showing a slight decrease.”

One such CDP is McLean, Virginia. According to wikipedia.org, McLean is a CDP with very high median household income. It describes McLean as follows:
“McLean is an unincorporated community located in Fairfax County in Northern Virginia. Recognized by the United States Census Bureau as a Census Designated Place (CDP), the community had a total population of 38,929 as of the 2000 census.
The heavily populated community of McLean is located between the George Washington Parkway and the town of Vienna, and is known for its many upscale homes and for being a friendly, efficient suburb of Washington. The area is also well-known for its shopping and upscale malls, including the nearby Tysons Corner Center and the Galleria. The George Washington Memorial Parkway, the Capital Beltway, Interstate 66, State Route 267 (Dulles Airport Access Road), State Route 123 (Dolley Madison Boulevard), State Route 193 (Old Georgetown Pike), Old Dominion Drive, and Chain Bridge Road all run through McLean.
McLean is home to many diplomats, members of Congress and high-ranking federal government officials, entrepreneurs and service businesses due to being near Washington, D.C. and being the location of the Central Intelligence Agency. It is also the home of former presidential advisor and presidential candidate Pat Buchanan, Supreme Court Justices Scalia and Kennedy, as well as the location of Hickory Hill, the former home of Ethel Kennedy, the widow of Robert F. Kennedy as well as home to Senator Edward Kennedy and Vice President Dick Cheney.
Several major companies are headquartered in McLean including Gannett, Freddie Mac, Capital One, and NVR. It is also the headquarters of USA Today and the candymaker Mars, Incorporated.
Several private schools are located in McLean, including The Madeira School, The Potomac School, and Oakcrest School. In addition, there are two public high schools; Langley High School and McLean High School.
Wikipedia.org describes McLean's demographics as follows:
As of the census GR2 of 2000, there are 38,929 people, 14,374 households and 11,053 families residing in the CDP. The population density is 812.9/km² (2,104.9/mi²). There are 14,735 housing units at an average density of 307.7/km² (796.7/mi²). The racial makeup of the CDP is 84.56% White, 1.58% African American, 0.10% Native American, 10.61% Asian, 0.03% Pacific Islander, 0.69% other races, and 2.44% multiracial. 4.02% of the population are Hispanic or Latino of any race.
There are 14,374 households, out of which 36.2% have children under the age of 18 living with them, 68.3% are married couples living together, 6.7% have a female householder with no husband present, and 23.1% are non-families. 18.6% of all households are made up of individuals and 9.5% have someone living alone who is 65 years of age or older. The average household size is 2.70 and the average family size is 3.05.
The CDP has no large population of any one age group, with 25.4% under the age of 18, 4.0% from 18 to 24, 23.5% from 25 to 44, 31.1% from 45 to 64, and 16.0% who are 65 years of age or older. The median age is 43 years. For every 100 females, there are 92.9 males. For every 100 females age 18 and over, there are 88.5 males.

The median income for a household in the CDP is $121,138, and the median income for a family is $137,610. Males have a median income of $93,065, versus $60,698 for females. The per capita income for the CDP is $63,209. 1.9% of the population and 0.8% of families are below the poverty line.
Out of the total population, 1.0% of those under the age of 18 and 2.3% of those 65 and older are living below the poverty line.
The organization known as McLean Youth Soccer could sell to advertisers the ability to place advertisement promotions within the e-mail messages between its coaches and its parents. This organization may have a website such as mcleansoccer.org. If there are 6,000 youth participants in McLean Youth Soccer dispersed on 400 teams with 400 head coaches generating 3 e-mails and 1 v-mail per week to 15 families, then there are 4 messages per week being sent to 6,000 families or 208 messages per year being sent to each of 6,000 families, or 1,248,000 messages per year being sent to families in McLean. This nonprofit, McLean Youth Soccer, has an asset—1,248,000 messages being sent per year. Without the present invention, it is unable to monetize the asset.

The median income for a household in the McLean CDP is $121,138. Some advertisers 20 who target high income earners and high net worth individuals would pay to access this target market, let alone through a method that virtually guarantees high readership of messages containing advertisements.

The promotion which is contained in the e-mail message may be purchased by an advertiser 20. The payment may be made in cash, or in some other form of value. A portion or percentage of the payment may be paid to the sender, to the receiver, to an organization or may be shared by all three. The advertisement may pertain to the sale of a product or service, or to a political position or candidate. In a particular embodiment, the advertisement may promote a luxury item. The sender, recipient or organization in which either is a member may have a financial interest in the advertisement.

### VI. Additional Alternative Embodiments of the Invention.

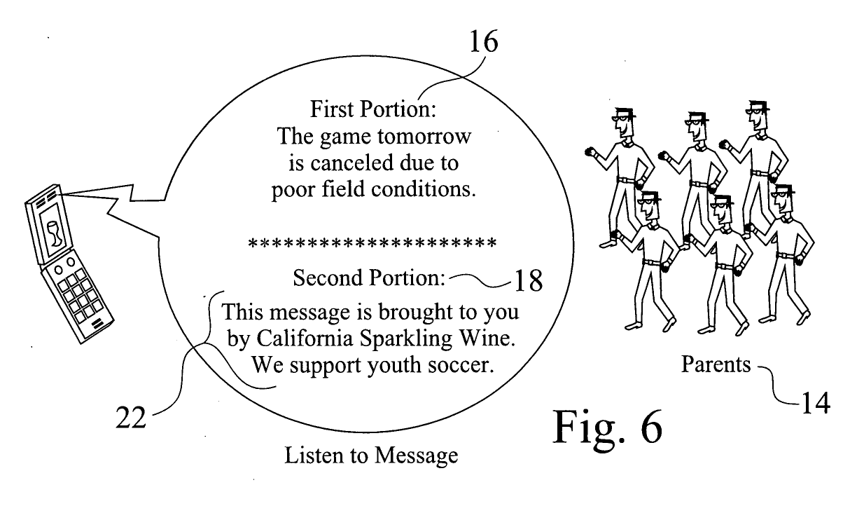

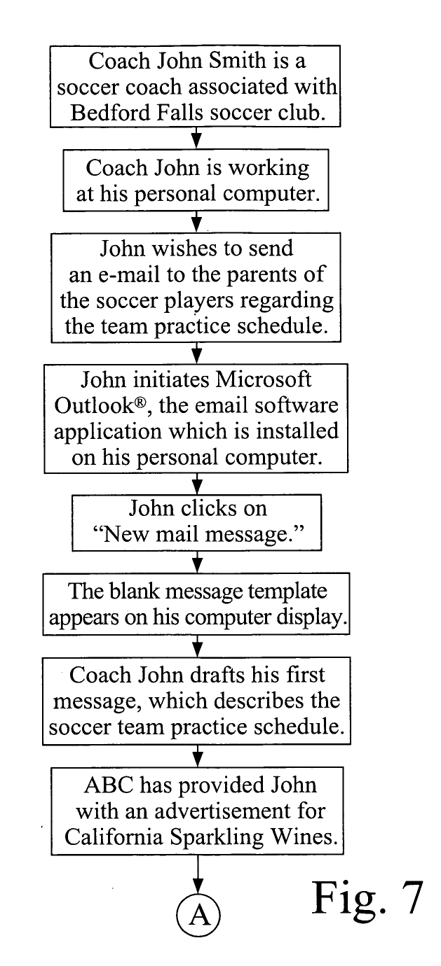

FIGS. 7, 8, 9 and 10 offer four additional flowcharts which illustrate specific embodiments of the invention.

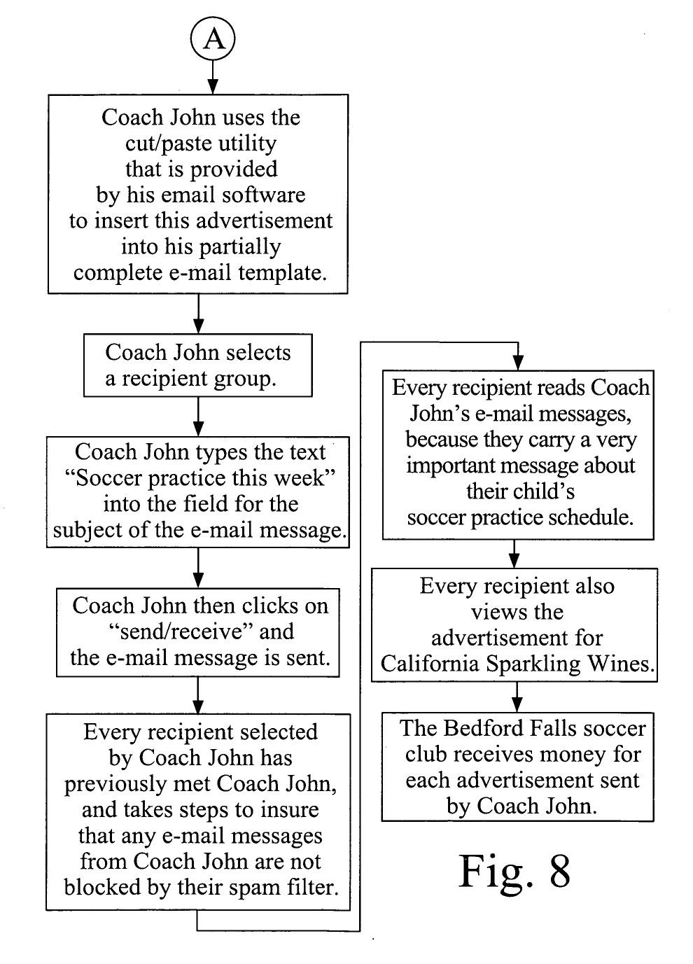

FIGS. 7 and 8 provide another specific example of the implementation of the invention. A Soccer Club, known as Bedford Falls, signs a contract with ABC

Company. ABC Company contracts with advertisers 20 to pay money to ABC Company, in return for the opportunity to place advertisements into the e-mail communications between soccer coaches and soccer parents associated with youth Soccer Clubs. ABC contributes some of the advertising revenue to the Soccer Club, such as Bedford Falls, whenever the Soccer Club or persons affiliated with the Soccer Club include approved advertisements when they send out email to other persons associated with the Soccer Club. FIG. 8 presents a list of steps which describe this embodiment:

Coach John Smith is a soccer coach associated with Bedford Falls Soccer Club.

Coach John is working on his personal computer.

John wishes to send an e-mail to the parents of the soccer players regarding the team practice schedule.

John initiates Microsoft Outlook®, the e-mail software application which is installed on his personal computer.

John clicks on “New mail message.”

A blank message template appears on his computer display.

Coach John drafts his first message, which describes the soccer team practice schedule.

ABC has provided John with an advertisement for California Sparkling Wines.

Coach John uses the cut/paste utility that is provided by his e-mail software to insert this advertisement into his partially complete e-mail template.

Coach John selects a recipient group.

Coach John types the text “Soccer practice this week” into the field for the subject of the e-mail message.

Coach John then clicks on “send/receive,” and the e-mail message is sent.

Every recipient selected by Coach John has previously met Coach John, and takes steps to insure that any e-mail messages from Coach John are not blocked by their spam filter.

Every recipient reads Coach John's e-mail messages, because they carry a very important message about their child's soccer practice schedule.

Every recipient also views the advertisement for California Sparkling Wines.

The Bedford Falls Soccer Club receives money for each advertisement that is sent by Coach John.

The Bedford Falls Soccer Club has 2,000 children participants, ranging in age from 6 to 18. There are 150 teams and 150 head coaches per year. There are 3 e-mails per week sent by each coach to 2,000 parents. Each week, there are 6,000 instances of parents reading e-mails from soccer coaches associated with Bedford Falls. Each year, there are 300,000 instances of parents reading e-mails from soccer coaches associated with Bedford Falls. If in the top one hundred markets, as ranked by household income per census designated place in the U.S., there are three Soccer Clubs per market with an average youth enrollment of 2,000, then each year, there could be 90 million instances of parents reading e-mails from soccer coaches, who are associated with the top 100 U.S. census designated places ranked by household income. The present invention will provide virtually an assured high percentage readership of the e-mails sent in accordance with this embodiment, compared with vastly lower rates of readership for other conventional forms of advertising.

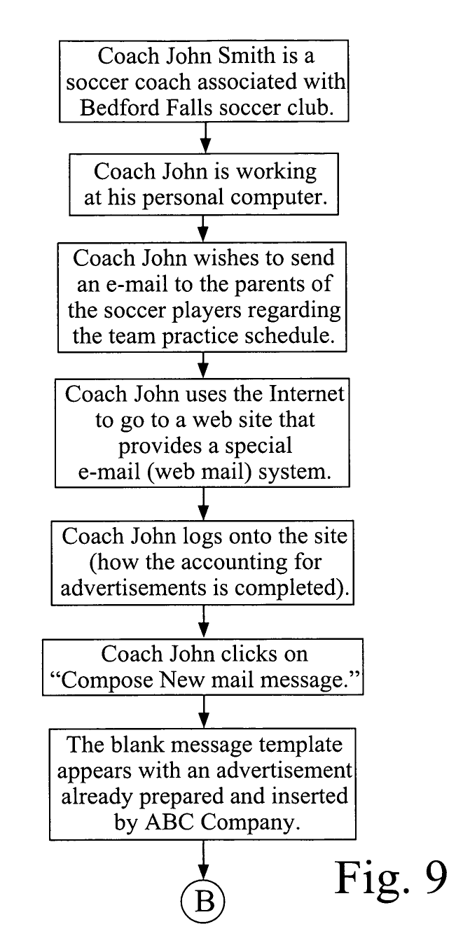

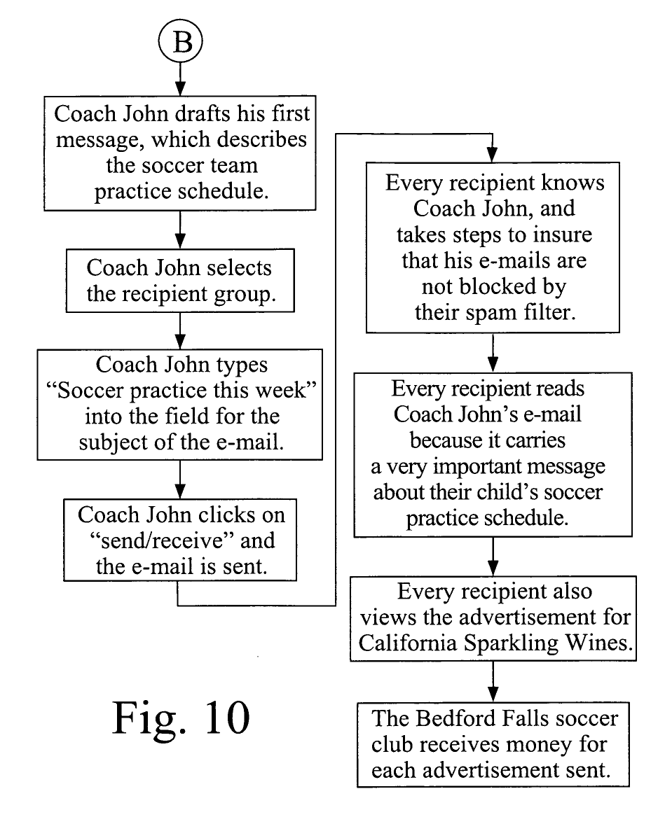

FIGS. 9 and 10 offer yet another example of the implementation of the invention. The Soccer Club, known as Bedford Falls, signs a contract with ABC Company. ABC Company gets advertiser 20 to pay money to ABC Company, in return for the opportunity to place advertisements into the e-mail communications among soccer coaches and soccer parents associated with youth Soccer Clubs. ABC contributes some of the advertising revenue to the Soccer Club, such as Bedford Falls, whenever the Soccer Club or persons affiliated with the Soccer Club include approved advertisements when they send out e-mail to other persons associated with the Soccer Club.

Coach John Smith is a soccer coach associated with Bedford Falls Soccer Club.

Coach John is working on his personal computer.

Coach John wishes to send an e-mail to the parents of the soccer players regarding the team practice schedule.

Coach John uses the Internet to go to a web site that provides a special e-mail (web mail) system.

Coach John logs onto the site (how the accounting for advertisements sent is completed).

Coach John clicks on “Compose New mail message.”

The blank message template appears with an advertisement already prepared and inserted by ABC Company.

Coach John drafts his first message, which describes the soccer team practice schedule.

Coach John selects the recipient group.

Coach John types “Soccer practice this week”into the field for the subject of the e-mail.

Coach John clicks on “send/receive,” and the e-mail is sent.

Every recipient knows Coach John, and takes steps to insure that his e-mails are not blocked by their spam filter.

Every recipient reads Coach John's e-mail because it carries a very important message about their child's soccer practice schedule.

Every recipient also views the advertisement for California Sparkling Wines.

The Bedford Falls Soccer Club receives money for each advertisement sent.

In this embodiment, the parents register directly with a Soccer Club, and the Club is a nonprofit organization that possesses contact information for the parents. In an alternative embodiment, the nonprofit organization is a Soccer League. Parents register with the Soccer League, which communicates directly with the parents.

In another embodiment, an intermediary could group together recipients into organizations (or the recipients could group themselves together) where they affiliate for the purpose of aggregating their demographic characteristics, creating inter organization messages and selling space on those messages to advertisers who seek access to the recipient group because of the demographic characteristics.

In another embodiment, employers, such as IBM, could sell to advertisers, such as Merrill Lynch, space on company e-mail to place Merrill Lynch advertisements. In this Specification and in the Claims that follow, the term “significant portion” is intended to describe a portion of a total number of recipients which is sufficient to encourage an advertiser to place an advertisement.

### VII. Selecting Recipients

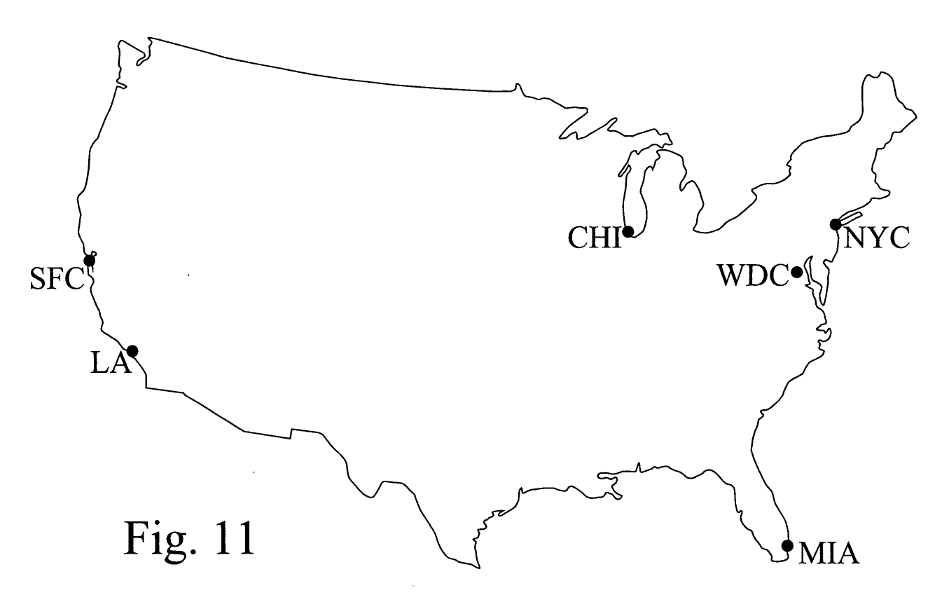

FIG. 11 is a simplified outline map of the continental United States, and shows the location of six major cities: New York, Washington, D.C., Miami, Chicago, San Francisco and Los Angeles. Each of these cities includes relatively affluent neighborhoods or regions.

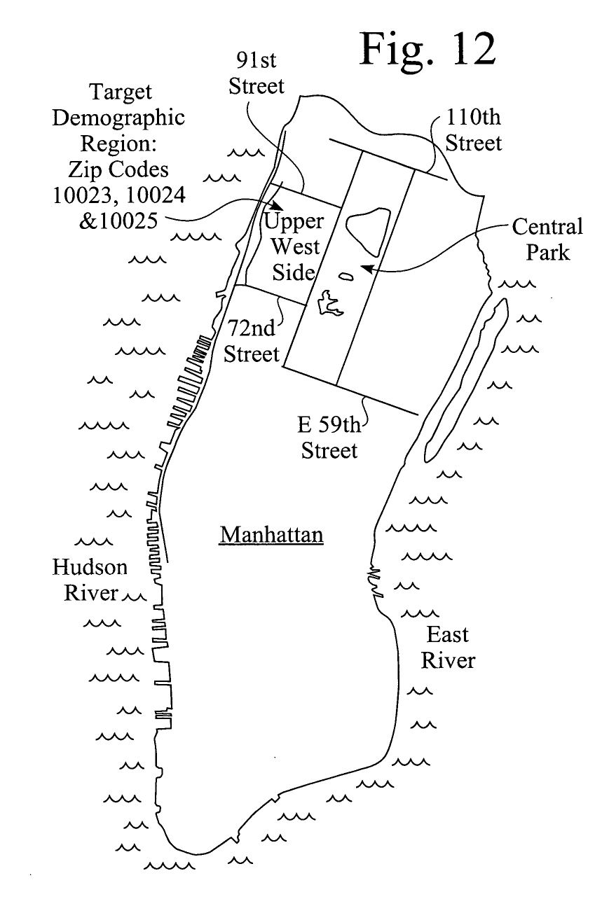

FIG. 12 provides a simplified outline map of Manhattan Island, in New York City. One affluent neighborhood or region in New York City is the Upper West Side, an area generally bounded by Central Park, 72nd Street, the Hudson River and 91st Street. The Postal Service Zip Codes for this neighborhood include 10023, 10024 and 10025.

In accordance with one embodiment of the present invention, recipients for messages are selected based on their residency in areas which are characterized by a set of demographics that are favored by the advertisers 20 who insert or embed promotions as the second portion of the messages that are sent to these recipients. Because the players and the parents of those players of the Upper West Side Soccer Club reside in a statistical area known for household income above the U.S. national median household income, some advertisers 20 would be inclined to select these individuals as recipients for e-mail messages that carry their promotional messages. Because the Upper West Side Soccer Club employs the present invention, they have something to sell to these advertisers 20.

### VIII. Generating Messages

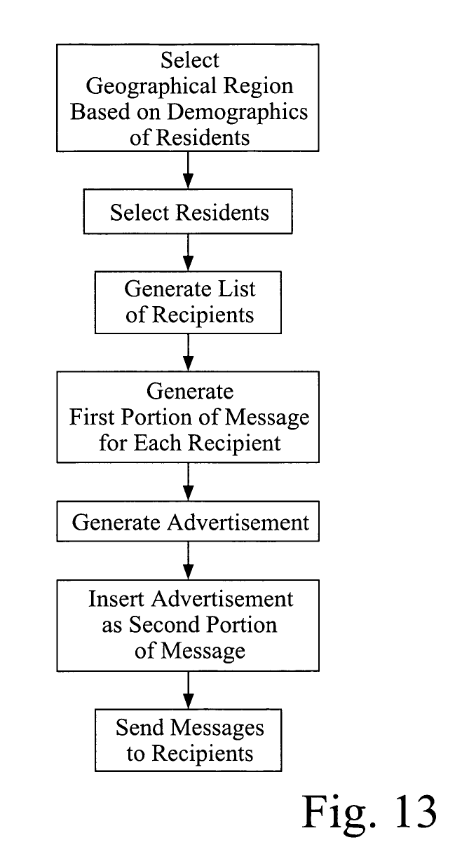

FIG. 13 offers a flow chart which illustrates one method of the invention. This embodiment comprises the following set of method steps:

Select geographical region based on demographics of residents

Select recipients who reside in this geographic region

Generate list of recipients

Generate First Portion of Message for each recipient

Generate Advertisement

Insert Advertisement as Second Portion of Message

Send Messages to Recipients

### IX. Aggregating Organizations for Advertisers

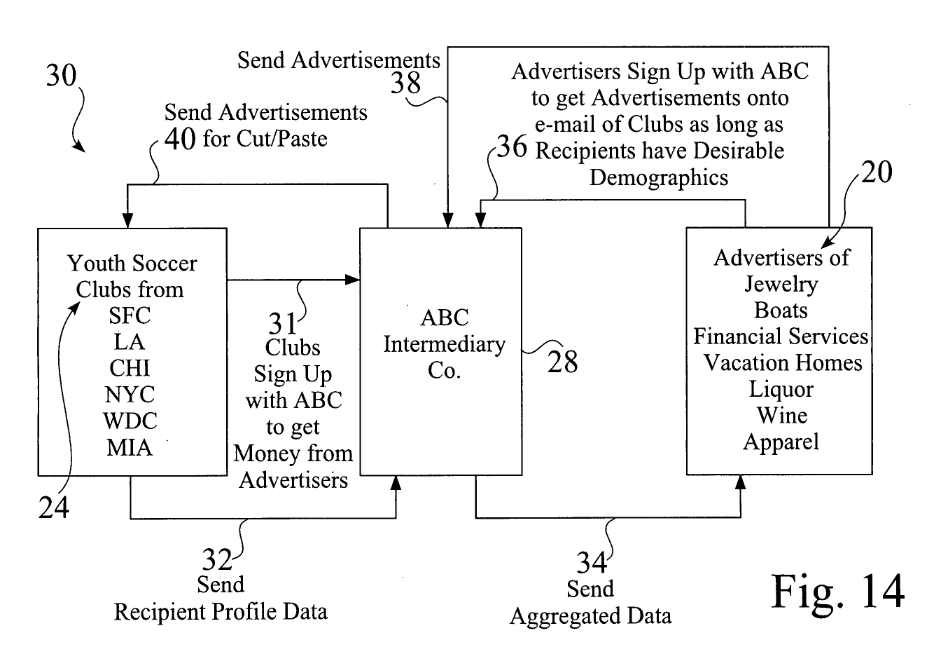

FIG. 14 is a flowchart 30 that illustrates one specific implementation of the invention. In the first step 31, Soccer Clubs sign up with an intermediary 28 known as ABC to get money from advertisers. In the second step 32, recipient profile data is sent from the organization 24 to ABC. In the third step 34, aggregated data is transmitted. In the next step 36, advertisers sign up with ABC to get advertisements onto e-mail of clubs as long as recipients have desirable demographics. In the next step 38, advertisements are sent to ABC. In the last step 40, ABC prepares the advertisement to be included in each organization's communications. In this case, the cut/paste method is used to insert the advertisement in the e-mail communications.

It is inefficient for non-profit organizations to solicit, sell, deliver, and service advertisers. Non-profits typically do not have the manpower or expertise to perform these functions. Furthermore, the advertisers 20 require a critical mass audience to justify the time and expenditure of their advertisements 22. In another embodiment, an intermediary 26 aggregates organizations 24 and provides to advertisers 20 the opportunity, and critical mass, to place advertisements 22 in multiple messages from and with affiliates of multiple geographically dispersed organizations 24.

FIG. 14 illustrates one embodiment of an intermediary 28. Youth Soccer Clubs from all over the U.S. sign up with ABC Intermediary Co. ABC provides a payment to the organization 24 in exchange for the placement of advertisements 22 in the organization's 24 messages 12. In one embodiment, the Soccer Clubs give to the intermediary 28 recipient profile data. The intermediary 28 aggregates the data from all participating clubs. The intermediary 26 gives the aggregated data to the advertisers 20. Advertisers 20 sign up with the intermediary 28. The advertiser 20 provides a payment to the intermediary 28 in exchange for the placement of advertisements 22 in organizations' 24 messages 12. The intermediary 28 is able to charge a premium to the advertiser 20 when the intermediary 28 represents a critical mass of recipients 14, which is accomplished by aggregating organizations 24. “Premium” means a fee larger than the fee that one organization acting on its own could get from one advertiser. Advertisers 20 then deliver to the intermediary 28 the advertisements 22 targeted for the recipients 14. The intermediary 28 delivers to the organizations 24 the advertisements 22, which will be inserted into the e-mail correspondence.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing an Assured Comprehension Advertising System that have been disclosed above are intended to educate the reader about preferred embodiments of the invention, and are not intended to constrain the limits of the invention or the scope of Claims.

### LIST OF REFERENCE CHARACTERS

10 Sender
12 Message
14 Recipient
16 First portion of message
18 Second portion of message
19 Set of parties who know one another through an affiliation with a common organization
20 Advertiser
22 Advertisement
23 Information pertaining to child and organization
24 Organization
25 Payment for advertisement
27 Affiliation
28 Intermediary
29 Consent
30 Flowchart
31 Clubs sign up with ABC to get money from advertisers
32 Send recipient profile data
34 Send aggregated data
36 Advertisers sign up with ABC to get advertisements onto e-mail of clubs as long as recipients have desirable demographics
38 Send advertisements
40 Send advertisements for cut/paste

what is claimed is:

1. A method comprising the steps of:
transmitting a message (12);
said message (12) being transmitted by a sender (10);
said message (12) being received by a recipient (14); and
composing said message (12) to include a first portion (16) and a second portion (18);
said sender (10) and said recipient (14) being limited to parties (19) who know of one another through an affiliation (27) with a common organization (24);
said organization (24) being a not-for-profit entity for providing benefits to children;
said recipient (14) is the parent of a child who participates in said organization (24);
said second portion (18) of said message (12) including an advertisement (22);
said advertiser (20) providing a payment (25) to said organization (24);
said organization (24) receiving a payment (25) from said advertiser (20) for the placement of said advertisement (22) in said message (12).

2. A method as recited in claim 1, in which said sender (10) is said organization (24).

3. A method as recited in claim 1, in which said sender (10) is an individual representative of said organization (24).

4. A method as recited in claim 1, in which said sender (10) is a youth sports organization and said recipient (14) is a parent of a youth who is a player in said youth sports organization.

5. A method as recited in claim 1, in which said sender (10) is an individual representative of a youth sports organization and said recipient (14) is a parent of a youth who is a player in said youth sports organization.

6. A method as recited in claim 1, in which said sender (10) is an individual who is a coach of a youth sports team and said recipient (14) is a parent of a youth who is a player on said coach's youth sports team.

7. A method as recited in claim 1, in which said message (12) is sent on behalf of school, and said recipient (14) is a parent of a child who is a student at said school.

8. A method as recited in claim 1, in which said sender (10) is an individual representative of a school and said recipient (14) is a parent of a child who is a student at said school.

9. A method as recited in claim 1, in which said message (12) is sent on behalf of a school and said recipient (14) is a student at said school.

10. A method as recited in claim 1, in which said sender (10) is an individual representative of a school and said recipient (14) is a student at said school.

11. A method as recited in claim 1, in which said sender (10) is a teacher at a school and said recipient (14) is a parent of a student at said school.

12. A method as recited in claim 1, in which said sender (10) and said recipient (14) being limited to individuals who know each other personally.

13. A method as recited in claim 1, in which said message (12) is conveyed by e-mail.

14. A method as recited in claim 1, in which said message (12) is conveyed by a web-mail system.

15. A method as recited in claim 1, in which said message (12) is conveyed by a voice message system.

16. A method as recited in claim 1, in which said message (12) is conveyed by an instant message.

17. A method as recited in claim 1, in which said message (12) viewed on a personal computer.

18. A method as recited in claim 1, in which said message (12) is viewed on an information appliance.

19. A method as recited in claim 1, in which said message (12) is heard on a telephone.

20. A method as recited in claim 1, in which said recipient (14) cooperates with said advertiser (20).

21. A method as recited in claim 1, in which said recipient (14) confirms the receipt of said message (12) for the benefit of said advertiser (20).

22. A method as recited in claim 1, in which said recipient (14) confirms, for the benefit of said advertiser (20), that said second portion (18) of said message (12) was read.

23. A method as recited in claim 1, in which said recipient (14) answers a survey for the benefit of said advertiser (20).

24. A method as recited in claim 1, in which said recipient (14) orders merchandise from said advertiser (20).

25. A method as recited in claim 1, in which said recipient (14) provides personal profile information, which is made available to said advertiser (20).

26. A method as recited in claim 6, in which said message (12) includes information pertaining to said youth sports team.

27. A method as recited in claim 27, in which said information concerning said sports team includes information pertaining to a schedule.

28. A method as recited in claim 1, in which said recipient (14) is selected based on a criteria attractive to said advertiser (20).

29. A method as recited in claim 1, in which said recipient (14) is selected from a geographical region characterized by high disposable income demographics.

30. A method comprising the steps of:
transmitting a message (12);
said message (12) being transmitted by a sender (10); and
receiving said message (12);
said message (12) being received by a plurality of said recipients (14);
said sender (10) and said recipient (14) being limited to parties (19) who know of one another through an affiliation (27) with a common organization (24);
a significant portion of said plurality of recipients (14) residing in a statistical area having a demographic characteristic which is attractive to an advertiser (20);
said message (12) including an advertisement (22);
said advertiser (20) providing a payment (25) to said organization (24);
said organization (24) receiving a payment (25) from said advertiser (20) in exchange for the placement of said advertisement (22) in said message (12).

31. A method as recited in claim 30, in which said demographic characteristic which is attractive to an advertiser (20) is that said recipient (14) resides in an area where median household income exceeds the national U.S. median household income.

32. A method as recited in claim 31, in which said sender (10) is a nonprofit organization (24), and said recipient (14) is an individual who is affiliated (27) with said nonprofit organization (24).

33. A method as recited in claim 31, in which said sender (10) is an individual representative of a nonprofit organization (24), and said recipient (14) is an individual who is affiliated (27) with said nonprofit organization (24).

34. A method as recited in claim 31, in which said organization (24) is a youth sports organization, and said recipient (14) is a parent of a youth who is a player in said youth sports organization.

35. A method as recited in claim 31, in which said sender (10) is an individual who is a coach of a youth sports team, and said recipient (14) is a parent of a youth who is a player on said coach's youth sports team.

36. A method as recited in claim 31, in which said organization (24) is a school, and said recipient (14) is a parent of a child who is a student at said school.

37. A method as recited in claim 30, in which said sender (10) is an employer, and said recipient (14) is an employee of said employer.

38. A method as recited in claim 30, in which said sender (10) is an individual representative of an employer, and said recipient (14) is an employee of said employer.

39. A method as recited in claim 31, in which said advertisement (22) is composed by an advertiser (20) who makes a payment (25) to said sender (10).

40. A method as recited in claim 31, in which said advertisement (22) is composed by an advertiser (20) who makes a payment to said recipient (14).

41. A method as recited in claim 31, in which said recipient (14) has contact with said advertiser (20) as a result of said message (12).

42. A method as recited in claim 31, in which said message (12) is viewed on an information appliance.

43. A method comprising the steps of:
transmitting a message (12);
said message (12) being transmitted by a sender (10); and
receiving said message (12);
said message (12) being received by a recipient (14);
said sender (10) and said recipient (14) being limited to parties (19) who know of one another through an affiliation (27) with a common organization (24);
said organization (24) being a not-for-profit entity for providing benefits to children;
said second portion (18) of said message (12) including an advertisement (22);
said advertiser (20) providing a payment (25) to an intermediary (28) in exchange for the placement of said advertisement (22) in said message;
said intermediary (28) providing a payment (25) to said organization (24) in exchange for the placement of said advertisement (22) in said message (12).

44. A method as recited in claim 43, in which said intermediary (28) provides said advertiser (20) with the placement of said advertisement (22) in said message (12).

45. A method as recited in claim 43, in which said intermediary (28) provides to said organization (24) a premium payment (26); said premium payment (26) being paid by said advertiser (20) to said intermediary (28) in exchange for the placement of said advertisement (20) with said organization (24).

46. A method as recited in claim 43, in which said organization (24) works with said intermediary (28) to have access to said advertiser (20) that seek to place said advertisement (22) with a said organization (24).

47. A method as recited in claim 43, in which said intermediary (28) works with said organization (24) for the placement of said advertisement (22) in said message (12).

48. A method comprising the steps of:
transmitting a message (12);
said message (12) being transmitted by a sender (10);
said message (12) being received by a plurality of said recipients (14); and
composing said message (12) to include a first portion (16) and a second portion (18);
said sender (10) and said recipient (14) being limited to parties (19) who know of one another through an affiliation (27) with a common organization (24);
a significant portion of said plurality of recipients (14) residing in a statistical area having a demographic characteristic which is attractive to an advertiser (20);
said second portion (18) of said message (12) including an advertisement (22);
said advertiser (20) providing a payment (25) to an intermediary (28) in exchange for the placement of said advertisement (22) in said message (12);
said intermediary (28) providing a payment (25) to said organization (24) in exchange for the placement of said advertisement (22) in said message (12).

49. A method as recited in claim 48, in which said demographic characteristic which is attractive to an advertiser (20) is that said recipient (14) resides in an area where median household income exceeds the national U.S. median household income.

50. A method as recited in claim 49, in which said intermediary (28) provides to said advertiser (20) with the placement of said advertisement (22) in said message.

51. A method as recited in claim 49, in which said intermediary (28) provides to said organization (24) a premium payment (26); said premium payment (26) being paid by said advertiser (20) to said intermediary (28) in exchange for the placement of a said advertisement (22) with said organization (24).

52. A method as recited in claim 49, in which said organization (24) works with said intermediary (28) to have access to said advertiser (20) that seek to place said advertisement (22) with said organization (24).

53. A method as recited in claim 49, in which said intermediary (28) works with said organization (24) for the placement of said advertisement (22) in said message (12).

54. A method as recited in claim 31, in which said recipient (14) provides consent (29) to the inclusion of said advertisement (22) in said message (12).

55. A method as recited in claim 43, in which said recipient (14) provides consent (29) to the inclusion of said advertisement (22) in said message (12).

56. A method as recited in claim 1, in which said recipient (14) provides consent (29) to the inclusion of said advertisement (22) in said message (12).

57. A method as recited in claim 48, in which said recipient (14) provides consent (29) to the inclusion of said advertisement (22) in said message (12).

58. A method as recited in claim 49, in which said intermediary (28) provides personal profile data about said recipient (14) from said organization (24) to said advertiser (22).

59. A method as recited in claim 43, in which said intermediary (28) provides personal profile data about said recipient (14) from said organization (24) to said advertiser (22).
